(19) United States
(12) Patent Application Publication
(10) Pub. No.: US 2026/0302931 A1
(43) Pub. Date: Oct. 1, 2026

(54) SEMICONDUCTOR DEVICE

(71) Applicant: Renesas Electronics Corporation, Tokyo (JP)

(72) Inventors: Atsushi TSUDA, Tokyo (JP); Kosuke YAYAMA, Tokyo (JP)

(21) Appl. No.: 19/537,035

(22) Filed: Feb. 11, 2026

(30) Foreign Application Priority Data
Mar. 31, 2025 (JP) 2025-060049

(51) Int. Cl. H02M 1/32; H02M 3/158

(52) U.S. Cl. CPC H02M 1/32; H02M 3/158

(57) ABSTRACT

An input power voltage is input to a LDO regulator, and the LDO regulator outputs an output power current IoutL and an output power voltage lower than the input power voltage to a power wiring. The input power voltage is input to a switched-capacitor circuit, and the switched-capacitor circuit outputs an output power current IoutS to the power wiring by performing switching in accordance with a clock signal to alternately perform switching between a charge operation and a discharge operation for a flying capacitor. A current detecting circuit detects a magnitude of the output power current IoutL. A clock supply circuit supplies the clock signal to the switched-capacitor circuit, based on a result detection of the current detecting circuit.

### CROSS-REFERENCE TO RELATED APPLICATION

The disclosure of Japanese Patent Application No. 2025-060049 filed on Mar. 31, 2025, including the specification, drawings and abstract is incorporated herein by reference in its entirety.

### BACKGROUND

The present invention relates to a semiconductor device, and relates to, for example, a semiconductor device including a voltage regulator.

There is disclosed technique listed below.

[Non-Patent Document 1] Yan Lu and other two, “An NMOS-LDO Regulated Switched-Capacitor DC-DC Converter With Fast-Response Adaptive-Phase Digital Control”, IEEE TRANSACTIONS ON POWER ELECTRONICS, VOL. 31, NO. 2, February 2016, pp. 1294 to 1303

The Non-Patent Document 1 describes a configuration in which a switched capacitor regulator and a low drop-out regulator (LDO) regulator are connected in series. The switched capacitor regulator generates power for the LDO regulator from an external power source, and supplies the power to the LDO regulator.

### SUMMARY

The voltage regulators can be roughly classified into two types that are a switching regulator type and a linear regulator type based on a difference in a conversion method. A high power efficiency can be achieved by use of a DC-DC converter that is the switching regulator. However, its demerit may be an increase in a bill-of-materials (BoM) cost due to an increase in a circuit area, mounting of an external elements and the like. In other words, such a DC-DC converter commonly requires a large external capacity, a large external inductor, and the like.

Also, by use of an LDO regulator that is the linear regulator, the number of external elements can be decreased, and the circuit area can also be decreased, and therefore, the BoM cost can be decreased. Further, quick load transient response can be achieved. However, its demerit may be a decrease in power efficiency. In other words, the LDO regulator loses a power based on a difference between an input power voltage and an output power voltage.

Under such circumstances, in recent years, low-power voltage regulators have been demanded typically in, for example, the field of energy harvesting. Therefore, application of DC-DC converters having high power efficiency has been studied. However, there is a non-negligible situation that is the increase in BoM cost due to the use of such a DC-DC converter. Thus, a system with combination of the switched capacitor regulator and the LDO regulator as a kind of the DC-DC converter is conceivable as described in, for example, the Non-Patent Document 1.

Use of the system described in the Non-Patent Document 1 mainly achieves the high power efficiency and the quick load transient response. However, the system requires that the switched capacitor regulator should output a voltage that is still higher than the output power voltage of the LDO regulator to the LDO regulator in order to normally operate the LDO regulator. Thus, the voltage difference between the input power voltage and the output power voltage in the switched capacitor regulator becomes small. In order to secure the desired current supply amount in a state of the small voltage difference as described above, it is necessary to increase a size of a flying capacitor configuring the switched capacitor regulator. As a result, the capacitor cannot be embedded into a chip, and the BoM cost may be increased.

Embodiments described later were made in view of the above. Other objects and novel characteristics will be apparent from the description of the present specification and the accompanying drawings.

A semiconductor device according to one embodiment includes a first power wiring, an LDO regulator, a switched-capacitor circuit, a current detecting circuit, and a clock supply circuit. Power is supplied to a predetermined load through the first power wiring. An input power voltage is input to the LDO regulator, and the LDO regulator outputs a first output power current and a first output power voltage lower than the input power voltage to the first power wiring. The input power voltage is input to the switched-capacitor circuit, and the switched-capacitor circuit outputs a second output power current to the first power wiring by performing switching in accordance with a clock signal to alternately perform switching between charge and discharge operations for a flying capacitor. The current detecting circuit detects a magnitude of the first output power current. The clock supply circuit supplies the clock signal to the switched-capacitor circuit, based on a detection result of the current detecting circuit.

According to the one embodiment, high power efficiency, quick load transient response and decrease in BoM cost can be achieved.

### BRIEF DESCRIPTIONS OF THE DRAWINGS

FIG. 1 is a circuit block diagram illustrating a schematic configuration example of a semiconductor device according to a first embodiment.

FIG. 2 is a circuit diagram illustrating a configuration example of an LDO regulator in FIG. 1.

FIG. 3A is a circuit diagram illustrating a configuration example of a switched-capacitor circuit in FIG. 1.

FIG. 3B is a timing chart illustrating a schematic operation example of a switch control circuit in FIG. 3A.

FIG. 4 is a schematic diagram illustrating comparisons in various electrical characteristics for a load current between the LDO regulator illustrated in FIG. 2 and the switched-capacitor circuit illustrated in FIG. 3A.

FIG. 5A is a schematic diagram for explaining a more detailed operation example of the switched-capacitor circuit illustrated in FIG. 3A.

FIG. 5B is a schematic diagram for explaining a more detailed operation example of the switched-capacitor circuit illustrated in FIG. 3A.

FIG. 6 is a circuit block diagram illustrating a schematic configuration example of a voltage regulator according to the first embodiment.

FIG. 7 is a schematic diagram illustrating an operation example of the voltage regulator illustrated in FIG. 6.

FIG. 8 is a schematic diagram illustrating another operation example of the voltage regulator illustrated in FIG. 6.

FIG. 9 is a circuit block diagram illustrating a more detailed configuration example of the voltage regulator illustrated in FIG. 6.

FIG. 10A is a circuit diagram illustrating a configuration example of a voltage controlled oscillator in FIG. 9.

FIG. 10B is a circuit diagram illustrating a configuration example of a ring oscillator in FIG. 10A.

FIG. 11 is a circuit block diagram illustrating a configuration example of a modification of the voltage regulator illustrated in FIG. 9.

FIG. 12 is a schematic diagram illustrating an operation example of the voltage regulator illustrated in FIG. 11.

FIG. 13 is a circuit block diagram illustrating a detailed configuration example of the voltage regulator illustrated in FIG. 6, in a semiconductor device according to a second embodiment.

FIG. 14 is a circuit block diagram illustrating a detailed configuration example of the voltage regulator illustrated in FIG. 6, in a semiconductor device according to a third embodiment.

FIG. 15 is a schematic diagram illustrating an operation example of the voltage regulator illustrated in FIG. 14.

FIG. 16 is a circuit block diagram illustrating a detailed configuration example of the voltage regulator illustrated in FIG. 6, in a semiconductor device according to a fourth embodiment.

FIG. 17 is a schematic diagram illustrating an arrangement example of the voltage regulator illustrated in FIG. 16 in the semiconductor device.

FIG. 18A is a circuit block diagram illustrating a detailed configuration example of the voltage regulator illustrated in FIG. 6, in a semiconductor device according to a fifth embodiment.

FIG. 18B is a circuit diagram illustrating a configuration example of the voltage controlled oscillator in FIG. 18A.

FIG. 19 is a timing chart illustrating an operation example of the voltage regulator illustrated in FIG. 18A.

FIG. 20 is a circuit block diagram illustrating a configuration example of a voltage regulator according to a comparative example.

### DETAILED DESCRIPTION

In the embodiments described below, the disclosure will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, when referring to the number of elements (including number of pieces, values, amount, range, and the like), the number of the elements is not limited to a specific number unless otherwise stated and except the case where the number is apparently limited to a specific number in principle. The number larger or smaller than the specified number is also applicable.

Further, in the embodiments, the components (including element steps) are not always indispensable unless otherwise stated and except the case where the components are apparently indispensable in principle. Similarly, when the shape of the components, positional relation thereof, and the like are mentioned, the substantially approximate and similar shapes and the like are included therein unless otherwise stated and except the case where it is conceivable that they are apparently excluded in principle. The same goes for the numerical value and the range described above.

In the embodiments, an MOS field effect transistor (MOSFET) is referred to as “MOS transistor”. A p-channel type MOSFET and an n-channel type MOSFET are referred to as “pMOS transistor” and “nMOS transistor”, respectively. The embodiments will be explained by using the MOS transistor using an oxide film as a gate insulating film, for the simplification of the explanation. However, the gate insulating film is not always limited to the oxide film.

Hereinafter, the embodiments of the present invention will be described in detail with reference to the drawings. Note that the same components are denoted with the same reference characters throughout all the drawings for describing the embodiments, and the repetitive description thereof will be omitted.

### First Embodiment

### <Summary of Semiconductor Device>

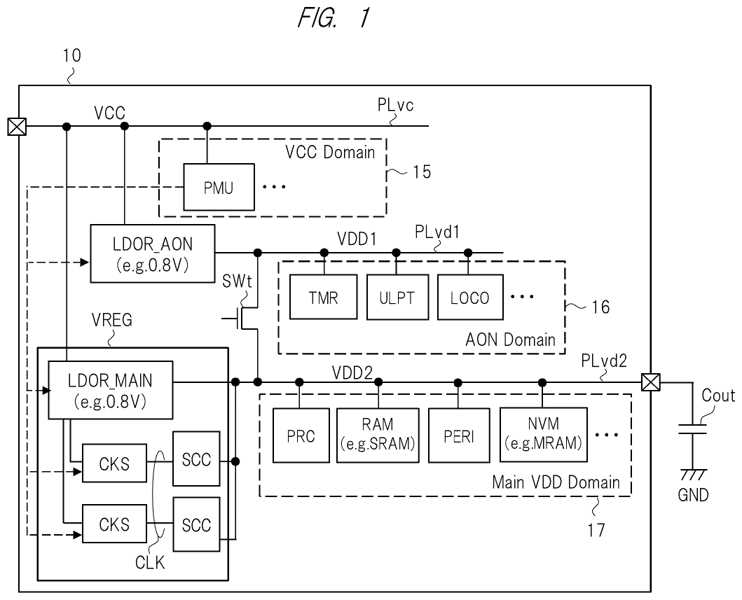

FIG. 1 is a circuit block diagram illustrating a schematic configuration example of a semiconductor device according to a first embodiment. The semiconductor device 10 illustrated in FIG. 1 is, for example, a microcontroller unit (MCU), a system on a chip (SoC), or the like, achieved by one semiconductor chip. The semiconductor device 10 includes an LDO regulator LDOR_AON, a voltage regulator VREG, an external power circuit 15, and two internal power circuits 16 and 17.

An external power voltage VCC is input to the LDO regulator LDOR_AON through a power wiring PLvc. The LDO regulator LDOR_AON generates an internal power voltage VDD1 that is lower than the external power voltage VCC, and outputs the internal power voltage VDD1 to a power wiring PLvd1. For example, the external power voltage VCC is about 3.3 V, and the internal power voltage VDD1 is about 0.8 V. Note that the external power voltage VCC may appropriately vary when being, for example, a battery voltage.

The external power voltage VCC is also input to the voltage regulator VREG through the power wiring PLvc. The voltage regulator VREG generates an internal power voltage VDD2 that is lower than the external power voltage VCC, and outputs the internal power voltage VDD2 to a power wiring PLvd2. For example, the internal power voltage VDD2 is also about 0.8 V. The voltage regulator VREG includes an LDO regulator LDOR_MAIN, a clock supply circuit CKS, and a switched-capacitor circuit SCC although described in detail later. In the present specification, each of the LDO regulators LDOR_AON and LDOR_MAIN is generically referred to as “LDO regulator LDOR”.

The external power circuit 15 is a circuit that is operated by the external power voltage VCC supplied through the power wiring PLvc. The external power circuit 15 includes, for example, a power management unit PMU. The power management unit PMU controls the active and inactive states of the LDO regulator LDOR_AON and the voltage regulator VREG.

The internal power circuit 16 is a circuit that is operated by the internal power voltage VDD1 supplied from the LDO regulator LDOR_AON through the power wiring PLvd1. The power management unit PMU controls the LDO regulator LDOR_AON to be in, for example, the active state even when the semiconductor device 10 is switched into a low-power mode. Thus, the internal power circuit 16 is a circuit that is always in an ON state (AON state). The internal power circuit 16 includes, for example, a timer TMR, a low-power timer ULPT, a low-frequency clock generator LOCO, and the like.

The internal power circuit 17 is a circuit that is operated by the internal power voltage VDD2 supplied through the power wiring PLvd2 from the voltage regulator VREG. The power management unit PMU controls the voltage regulator VREG to be in, for example, the inactive state when the semiconductor device 10 is switched into the low-power mode. The power management unit PMU controls the voltage regulator VREG to be in the active state when the semiconductor device 10 is operated in a normal mode. Thus, the internal power circuit 17 is a main circuit that performs a normal operation of the semiconductor device 10.

The internal power circuit 17 includes, for example, a processor PRC, a volatile memory RAM, a nonvolatile memory NVM, various peripheral circuits PERI, and the like. The processor PRC is typically a central processing unit (CPU). The volatile memory RAM is, for example, a static random access memory (SRAM). The nonvolatile memory NVM is, for example, a magnetoresistive RAM (MRAM). In this case, the processor PRC executes a predetermined program stored in the MRAM while using the SRAM as a temporal memory.

Note that a test switch SWt illustrated in FIG. 1 is controlled to be in an ON state in testing, thereby connecting the two power wirings PLvd1 and PLvd2 to each other. As a result, in the testing, for example, a test power can be supplied from a test terminal to the two power wirings PLvd1 and PLvd2 in common. In FIG. 1, the power wiring PLvd2 is connected to, for example, an output capacitor Cout arranged outside the semiconductor device 10. The output capacitor Cout may be arranged in the semiconductor device 10.

### <Component of Voltage Regulator>

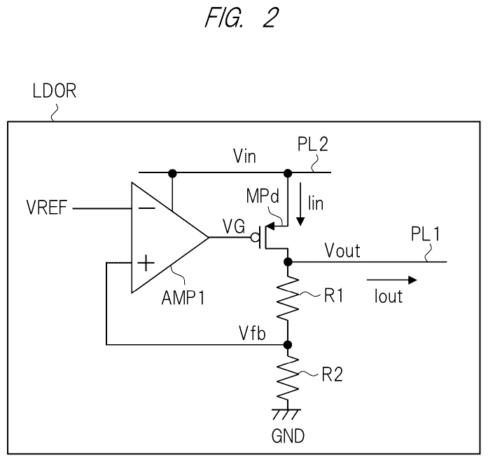

FIG. 2 is a circuit diagram illustrating a configuration example of the LDO regulator LDOR in FIG. 1. The LDO regulator LDOR illustrated in FIG. 2 includes a pMOS transistor MPd, resistor elements R1 and R2, and an amplifier circuit AMP1. The pMOS transistor (output transistor) MPd is connected between a power wiring PL2 to which an input power voltage Vin is applied and a power wiring PL1 to which an output power voltage Vout is output. The output power voltage Vout is a voltage stepped down from the input power voltage Vin through the output transistor.

The amplifier circuit AMP1 applies a gate voltage (control voltage) VG to the pMOS transistor MPd such that an error between the value of the output power voltage Vout and a target value approaches zero. Specifically, the amplifier circuit AMP1 outputs the gate voltage VG such that a feedback voltage Vfb and a reference voltage VREF corresponding to the target value are equal to each other. The feedback voltage Vfb is generated by dividing the resistance between the output power voltage Vout and a ground power voltage GND while using two resistor elements R1 and R2 that are high-resistance elements.

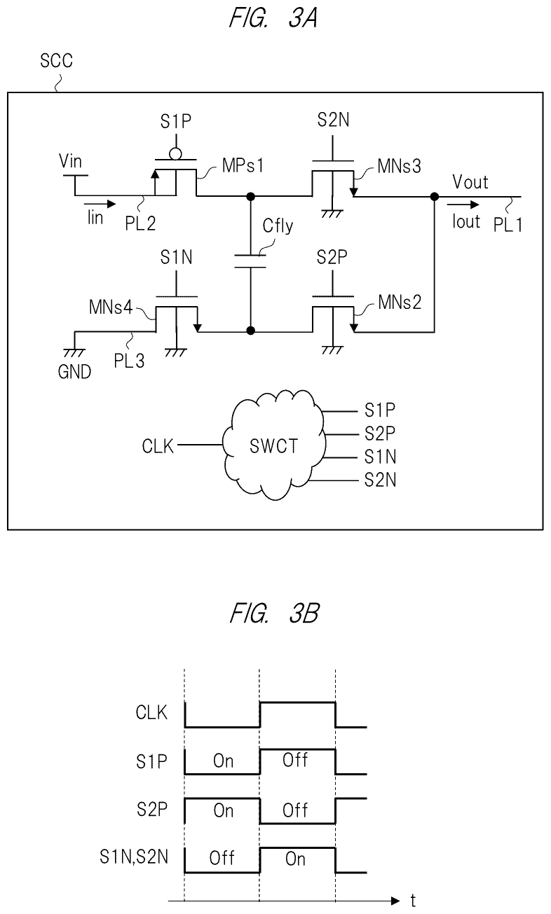

FIG. 3A is a circuit diagram illustrating a configuration example of the switched-capacitor circuit SCC in FIG. 1. FIG. 3B is a timing chart illustrating a schematic operation example of a switch control circuit SWCT in FIG. 3A. FIG. 3A illustrates the switched-capacitor circuit SCC having, for example, “voltage conversion ratio (VCR)=1/2”. The switched-capacitor circuit SCC includes four switches, one flying capacitor Cfly, and the switch control circuit SWCT.

The four switches are made of, for example, one pMOS transistor MPs1 and three nMOS transistors MNs2 to MNs4. The pMOS transistor MPs1 and the nMOS transistor MNs3 are connected in series between the power wiring PL2 to which the input power voltage Vin is applied and the power wiring PL1 to which the output power voltage Vout is output. The two nMOS transistors MNs2 and MNs4 are connected in series between the power wiring PL1 and the power wiring PL3 to which the ground power voltage GND is applied.

The flying capacitor Cfly is connected between a shared node of the pMOS transistor MPs1 and the nMOS transistor MNs3 and a shared node of the two nMOS transistors MNs2 and MNs4. The switch control circuit SWCT generates switching signals S1P, S2P, S1N, and S2N for the four switches in synchronization with an input clock signal CLK.

The switching signal S1P performs on-off control of the pMOS transistor MPs1. The switching signal S2P performs on/off control of the nMOS transistor MNs2. The switching signal S1N performs on/off control of the nMOS transistor MNs4. The switching signal S2N performs on/off control of the nMOS transistor MNs3.

As illustrated in FIG. 3B, in a “L” level period of the clock signal CLK, the switch control circuit SWCT controls the two switching signals S1P and S2P to be in an ON level, and the two switching signals S1N and S2N to be in an OFF level. In this case, the input power voltage Vin and the output power voltage Vout are applied to both the ends of the flying capacitor Cfly. As a result, the flying capacitor Cfly performs a charge operation, based on an input power current Iin flowing through the power wiring PL2.

On the other hand, in a “H” level period of the clock signal CLK, the switch control circuit SWCT controls the two switching signals S1N and S2N to be in an ON level, and the two switching signals S1P and S2P to be in an OFF level. In this case, the ground power voltage GND and the output power voltage Vout are applied to both the ends of the flying capacitor Cfly. As a result, the flying capacitor Cfly performs a discharge operation by making flow of the output power current Iout to the power wiring PL1.

As described above, the input power voltage Vin is input to the switched-capacitor circuit SCC, and the switched-capacitor circuit SCC alternately performs the switching between the charge operation and the discharge operation for the flying capacitor Cfly by performing the switching in accordance with the clock signal CLK. As a result, the switched-capacitor circuit SCC outputs the output power current Iout to the power wiring PL1.

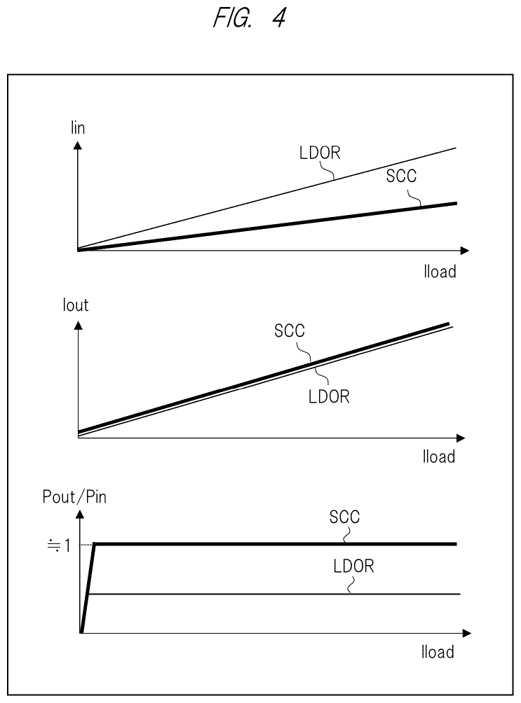

FIG. 4 is a schematic diagram illustrating comparisons in various electrical characteristics for a load current between the LDO regulator LDOR illustrated in FIG. 2 and the switched-capacitor circuit SCC illustrated in FIG. 3A. FIG. 4 illustrates relationships between the load current Iload and the input power current Iin, the output power current Iout, and a power efficiency “Pout/Pin”. The LDO regulator LDOR and the switched-capacitor circuit SCC generate the same output power current Iout.

In the LDO regulator LDOR, the input power current Iin flowing through the power wiring PL2 is the same as the output power current Iout. In other words, currents flowing through the resistor elements R1 and R2 in FIG. 2 are negligible because the resistor elements R1 and R2 are high-resistance elements. On the other hand, the input power current Iin of the switched-capacitor circuit SCC in the case of “VCR=1/2” is 1/2 of the output power current Iout.

The power efficiency “Pout/Pin” is determined as “(Vout*Iout)/(Vin*Iin)”. The power efficiency of the LDO regulator LDOR is “Vout/Vin” because of “Iin=Iout”. For example, in the case of “Vout=Vin/2”, the power efficiency of the LDO regulator LDOR is “0.5”. On the other hand, the power efficiency of the switched-capacitor circuit SCC is ideally “1.0” because of “Iin=Iout/2” and “Vout=Vin/2”. As described above, the switched-capacitor circuit SCC can achieve the higher power efficiency than that of the LDO regulator LDOR.

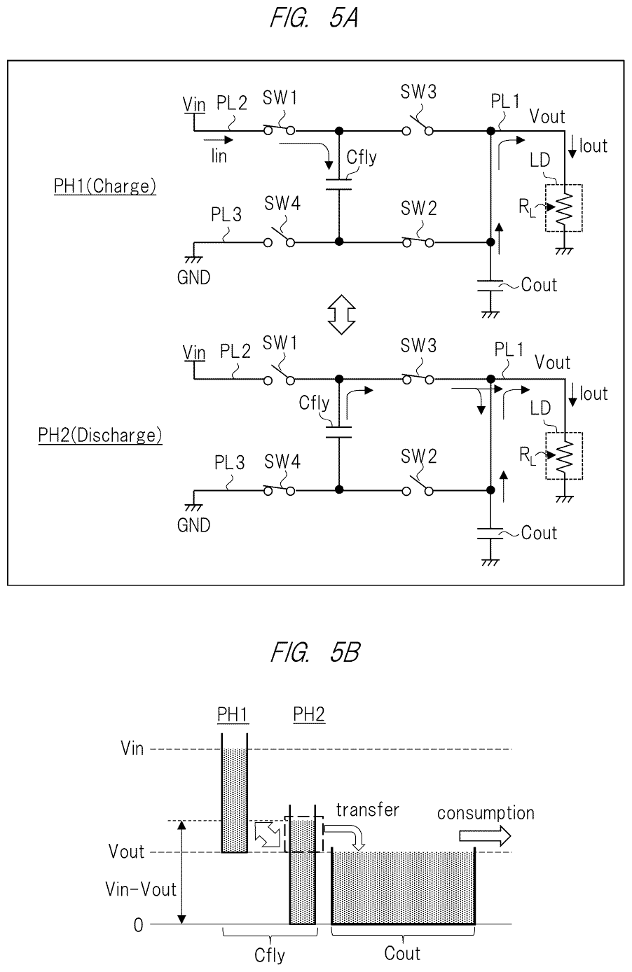

FIGS. 5A and 5B are schematic diagrams for explaining a more detailed operation example of the switched-capacitor circuit SCC illustrated in FIG. 3A. FIG. 5A illustrates the charge operation and discharge operation illustrated in FIG. 3A, that is, the ON/OFF states of four switches SW1 to SW4 in a charge phase PH1 and a discharge phase PH2. The output capacitor Cout and the load LD are connected to the power wiring PL1 through which the output power voltage Vout and the output power current Iout are output. The load LD is represented by a load resistor element R_{L.}

In the charge phase PH1, the flying capacitor Cfly is charged in a state in which the flying capacitor Cfly and the output capacitor Cout are connected in series. In this case, the input power voltage Vin is applied to the flying capacitor Cfly, based on the output power voltage Vout. Thus, the input power current Iin flows through the power wiring PL2. On the other hand, in the discharge phase PH2, discharge from the flying capacitor Cfly to the output capacitor Cout is performed in a state in which the flying capacitor Cfly and the output capacitor Cout are connected in parallel.

In terms of an amount of transferred charge in the flying capacitor Cfly, an average value “Iin (ave)” of the input power current Iin can be determined by Equation (1). As illustrated in FIG. 5B, in the charge phase PH1, the amount of charge based on “Vin−Vout” is charged to the flying capacitor Cfly. In the discharge phase PH2 after that, the amount of charge based on the voltage difference “Vin−2Vout” between “Vin−Vout” and “Vout” is transferred to the output capacitor Cout. The average value “Iin (ave)” of the input power current Iin is determined based on the amount of the transferred charge. In Equation (1), a term “f” is a frequency of the clock signal CLK.

$$Iin ( ave ) = Cfly ( Vin - 2 Vout ) * f \qquad ( 2 )$$

An average value “Iout (ave)” of the output power current Iout is “Iout=2*Iin” as described above, and is therefore determined by Equation (2). Meanwhile, in a load resistor element R_{L}, a relationship of “Iout (ave)=Vout/R_{L}” is established. Based on the relationship and Equation (2), the output power voltage Vout is determined by Equation (3). As clearly seen from Equation (2) and FIG. 5B, in the case of “Vin≤2Vout”, the switched-capacitor circuit SCC loses an ability to supply the current. As clearly seen from Equation (3), the increase in the frequency “f” of the clock signal CLK converges the output power voltage Vout to a voltage value of “Vin/2”.

$$Iout ( ave ) = 2 Cfly ( Vin - 2 Vout ) * f \qquad ( 2 )$$

$$Vout = ( 2 Cfly * f * {R}_{L} ) / ( 4 Cfly * f * {R}_{L} + 1 ) * Vin \qquad ( 3 )$$

### <Voltage Regulator (Comparative Example)>

First, a system in the Non-Patent Document 1 is described. In the system, the switched-capacitor circuit SCC is connected in series to the LDO regulator LDOR, and outputs the input power voltage Vin to the LDO regulator LDOR. In this case, from the switched-capacitor circuit SCC, it is necessary to output a voltage that is higher than the output power voltage Vout of the LDO regulator LDOR by a drain-source voltage (VDS) of the pMOS transistor MPd. In other words, the switched-capacitor circuit SCC needs to ensure the drain-source voltage (VDS) of the pMOS transistor MPd.

Thus, the voltage difference between the input power voltage Vin and the output power voltage Vout in the switched-capacitor circuit SCC becomes small. In order to ensure the desired amount of supplied current in such a state, it is necessary to increase the frequency “f” of a clock signal CLK or to increase the size of the flying capacitor Cfly, as clearly seen from Equation (2). Practically, the frequency “f” can increase up to only some extent, and therefore, it is necessary to increase the size of the flying capacitor Cfly. As a result, it is difficult to form the flying capacitor Cfly as the on-chip flying capacitor, and the BoM cost may be increased.

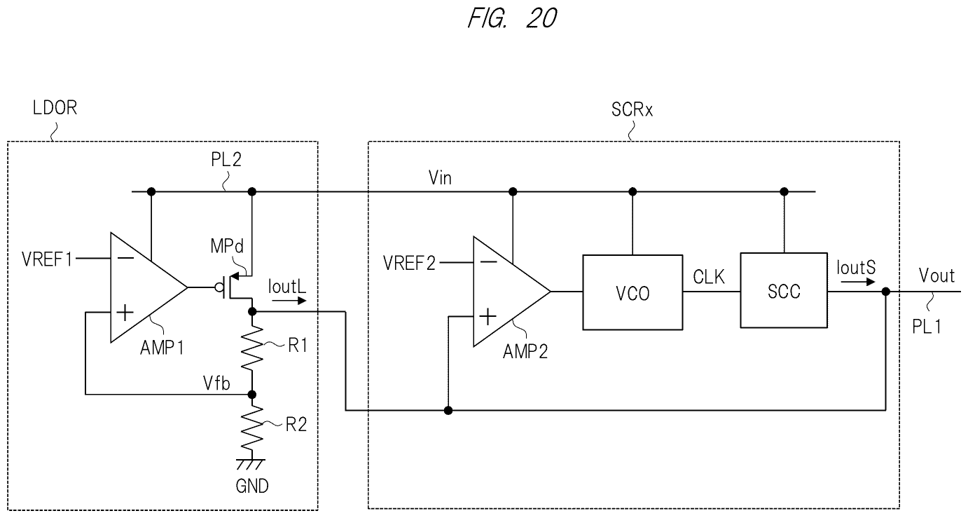

Thus, it is conceivable to use, for example, a system as illustrated in FIG. 20. FIG. 20 is a circuit block diagram illustrating a configuration example of a voltage regulator according to a comparative example. In FIG. 20, a switched capacitor regulator SCRx is connected in parallel with the LDO regulator LDOR. The switched capacitor regulator SCRx and the LDO regulator LDOR are operated independently of each other, and output the output power voltages Vout to the common power wiring PL1. The switched capacitor regulator SCRx includes an amplifier circuit AMP2, a voltage controlled oscillator VCO, and the switched-capacitor circuit SCC.

The amplifier circuit AMP2 detects the error between the output power voltage Vout and a reference voltage VREF2. The voltage controlled oscillator VCO generates the clock signal CLK, and controls the frequency “f” of the clock signal CLK, based on the detected error. The switched-capacitor circuit SCC performs switching operation, based on the clock signal CLK from the voltage controlled oscillator VCO, thereby outputting an output power current IoutS to the power wiring PL1. In such a manner, the switched capacitor regulator SCRx generates the output power current IoutS such that the error between the output power voltage Vout and a target voltage, that is, a reference voltage VREF2 approaches zero.

The parallel connection system as described above is different from the series connection system described above in that the switched capacitor regulator SCRx does not need to ensure the drain-source voltage (VDS) of the pMOS transistor MPd. Thus, the voltage difference between the input power voltage Vin and the output power voltage Vout in Equation (2) can be ensured to some extent. As a result, the size of the flying capacitor Cfly can be downsized to form the flying capacitor Cfly as the on-chip flying capacitor.

However, in the system illustrated in FIG. 20, an output power current IoutL of the LDO regulator LDOR and the output power current IoutS of the switched capacitor regulator SCRx are generated independently of each other. Therefore, a supply source of the output power current to the load may be lean to ether one of the regulators.

Specifically, the target voltage of each regulator may differ depending on, for example, the offset difference between the amplifier circuit AMP1 in the LDO regulator LDOR and the amplifier circuit AMP2 in the switched capacitor regulator SCRx. The supply source of the output power current leans to the regulator with the higher target voltage. When the supply source leans to the LDO regulator LDOR, it is difficult to enhance the power efficiency. On the other hand, when the supply source leans to the switched capacitor regulator SCRx, it is particularly difficult to increase the speed of the load transient response. In other words, it is difficult to achieve both the merits. Thus, use of a system described below is beneficial.

### <Summary of Voltage Regulator (Embodiment)>

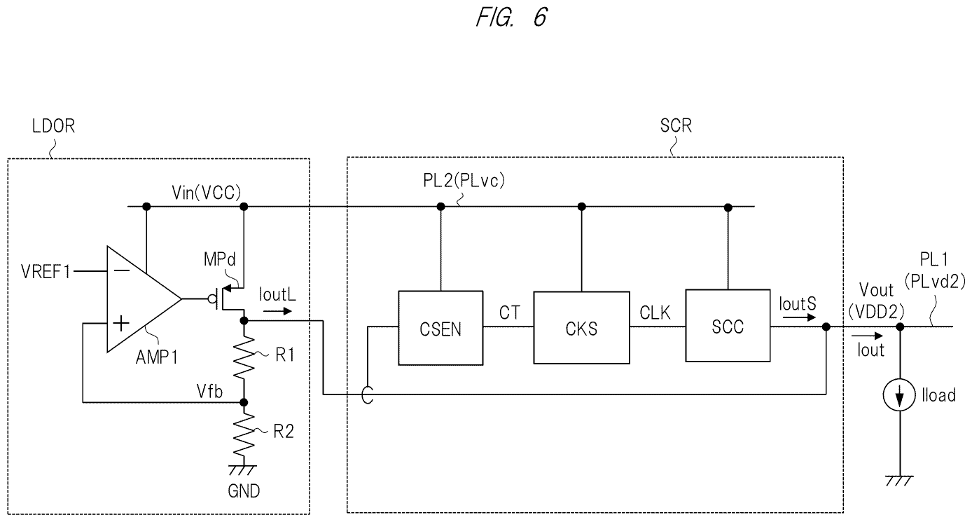

FIG. 6 is a circuit block diagram illustrating a schematic configuration example of the voltage regulator according to the first embodiment. The voltage regulator illustrated in FIG. 6 is applied to, for example, the voltage regulator VREG illustrated in FIG. 1, and supplies the power to the internal power circuit 17. As similar to the case of FIG. 20, this voltage regulator includes the LDO regulator LDOR and the switched capacitor regulator SCR connected in parallel.

The input power voltage Vin is input to the LDO regulator LDOR through a power wiring (second power wiring) PL2. The LDO regulator LDOR outputs an output power current (first output power current) IoutL and an output power voltage Vout which is lower than the input power voltage Vin to a power wiring (first power wiring) PL1. With reference to FIG. 1, the power wiring PL2 and the input power voltage Vin correspond to the power wiring PLvc and the external power voltage VCC, respectively. The power wiring PL1 and the output power voltage Vout correspond to the power wiring PLvd2 and the internal power voltage VDD2, respectively. Through the power wiring PL1, the power is supplied to a predetermined load such as the internal power circuit 17 used for making the flow of the load current Iload.

The switched capacitor regulator SCR includes a current detecting circuit CSEN and a clock supply circuit CKS in addition to the switched-capacitor circuit SCC. The switched-capacitor circuit SCC includes a configuration as illustrated in FIG. 3A. Schematically, the same input power voltage Vin as that of the LDO regulator LDOR is input to the switched-capacitor circuit SCC. The switched-capacitor circuit SCC alternately performs the switching between the charge operation and the discharge operation for the flying capacitor Cfly by performing the switching in accordance with the clock signal CLK. As a result, the switched-capacitor circuit SCC outputs the output power current (second output power current) IoutS to the same power wiring PL1 as that of the LDO regulator LDOR.

The current detecting circuit CSEN detects the magnitude of the output power current IoutL output from the LDO regulator LDOR. The clock supply circuit CKS supplies the clock signal CLK to the switched-capacitor circuit SCC, based on a control signal CT representing the detection result of the current detecting circuit CSEN. By using such a configuration, as different from the case of FIG. 20, the relationship between the output power current IoutL from the LDO regulator LDOR and the output power current IoutS from the switched capacitor regulator SCR can be established. Specifically, the output power current IoutS can be controlled based on the magnitude of the output power current IoutL.

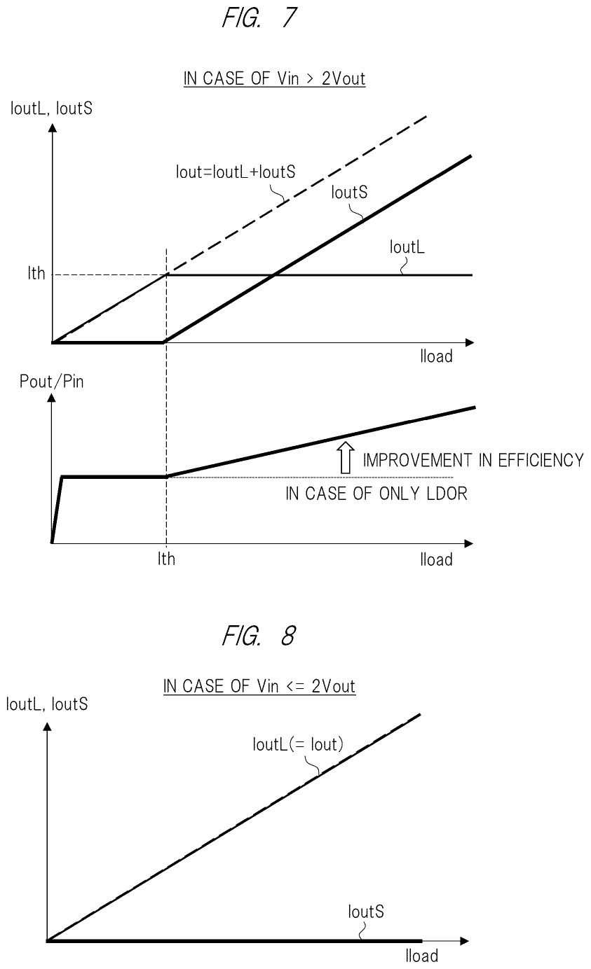

FIG. 7 is a schematic diagram illustrating an operation example of the voltage regulator illustrated in FIG. 6. FIG. 7 illustrates relationships between the load current Iload, the two output power currents IoutL and IoutS, and the power efficiency “Pout/Pin”. Note that FIG. 7 is based on the premise that “Vin>2Vout” is satisfied, that is, the switched-capacitor circuit SCC has an ability to supply the current. The load current Iload is equal to an output power current Iout (=IoutL+IoutS) that is a sum of the two output power currents IoutL and IoutS.

More specifically, the clock supply circuit CKS starts the supply of the clock signal CLK to the switched-capacitor circuit SCC when the output power current IoutL from the LDO regulator LDOR is larger than a threshold value Ith. The clock supply circuit CKS performs control such that the frequency “f” of the clock signal CLK increases in response to the increase in the output power current IoutL, resulting from the increase in the load current Iload. As a result, the clock supply circuit CKS performs control such that the increase of the load current Iload is compensated by the output power current IoutS of the switched-capacitor circuit SCC.

in the range of the operation of the switched-capacitor circuit SCC, such control suppresses the increase in the output power current IoutL output from the LDO regulator LDOR. In other words, the output power current IoutL becomes substantially constant. In the range of the operation of the switched-capacitor circuit SCC, the larger the output power current IoutS output from the switched-capacitor circuit SCC is, the larger the power efficiency “Pout/Pin” for the voltage regulator is.

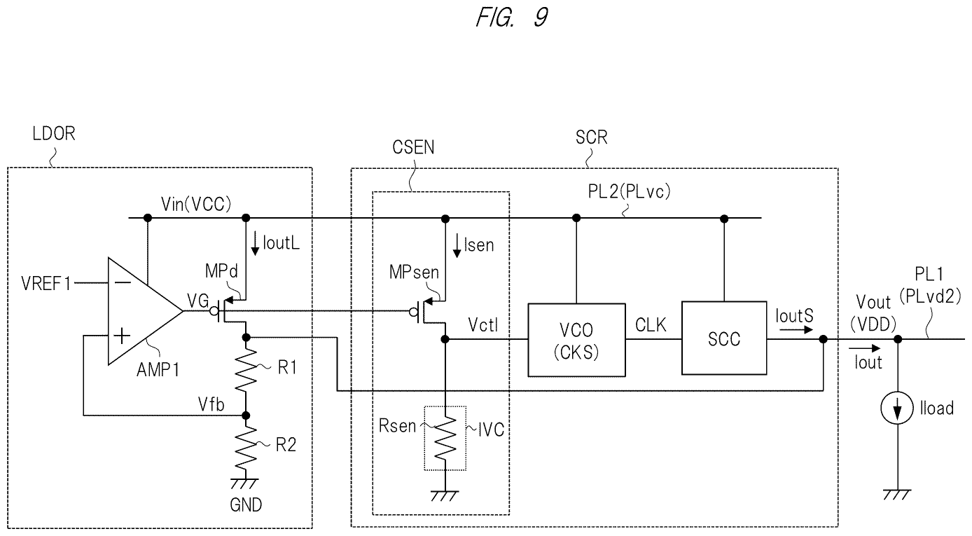

FIG. 8 is a schematic diagram illustrating another operation example of the voltage regulator illustrated in FIG. 6. FIG. 8 illustrates relationships between the load current Iload and the two output power currents IoutL and IoutS. As different from the case of FIG. 7, the premise of this case is that the relation “Vin≤2Vout” is satisfied, that is, the switched-capacitor circuit SCC loses the ability to supply the current. Even in this case, the output power current Iout to the load can be maintained by the LDO regulator LDOR. On the other hand, for example, in the series connection system described in the Non-Patent Document 1, the LDO regulator LDOR also loses the ability to supply the current when the switched-capacitor circuit SCC loses the ability to supply the current.

The decrease in the input power voltage Vin can increase the power efficiency of the LDO regulator LDOR by the degree of the decrease. Therefore, a merit capable of decreasing the the lower limit of the input power voltage Vin, for example, capable of handling the decrease in the battery voltage is greater than a demerit resulting from the power efficiency. In other words, by the use of the parallel connection system, the wider range of the input power voltage Vin than that of the series connection system can be achieved.

As described above, the high power efficiency, the quick load transient response, and the decrease in BoM cost can be achieved by using the voltage regulator illustrated in FIG. 6. In other words, both of the merit of the LDO regulator LDOR and the merit of the switched-capacitor circuit SCC can be achieved to be well-balanced as different from the case of FIG. 20. More specifically, since the output power current IoutS output from the switched-capacitor circuit SCC is increased by the increase in the load current Iload, the higher power efficiency than that of the case of the single LDO regulator LDOR can be achieved.

Also, since a certain amount of the output power current IoutL output from the LDO regulator LDOR is always ensured, the quick load transient response equivalent to that of the case of the single LDO regulator LDOR can be achieved. Furthermore, by the use of the parallel connection system, the size of the flying capacitor Cfly can be downsized as similar to the case of FIG. 20. As a result, since the on-chip flying capacitor Cfly can be formed as the on-chip flying capacitor, the BoM cost can be decreased.

### <Details of Voltage Regulator>

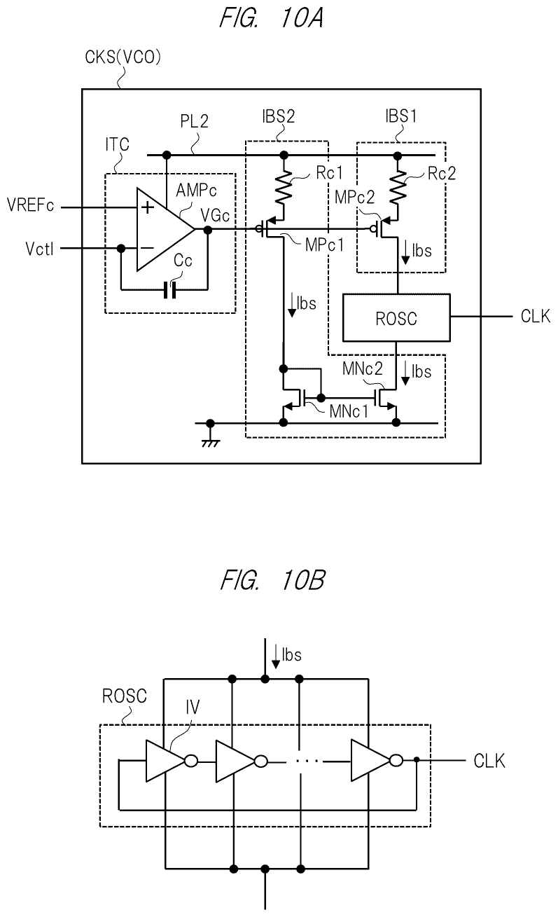

FIG. 9 is a circuit block diagram illustrating a more detailed configuration example of a voltage regulator illustrated in FIG. 6. A voltage regulator illustrated in FIG. 9 differs from the configuration example illustrated in FIG. 6 in the following two points. A specific configuration example of the current detecting circuit CSEN is illustrated as the first difference. The second difference is that the clock supply circuit CKS is made of the voltage controlled oscillator VCO.

The current detecting circuit CSEN includes a pMOS transistor MPsen and a sense resistor element Rsen. The pMOS transistor MPsen is made of a transistor set to have a predetermined size ratio to the pMOS transistor (output transistor) MPd of the LDO regulator LDOR.

Specifically, a transistor size, specifically a gate width of the pMOS transistor MPsen is formed to be, for example, one several thousands of that of the pMOS transistor MPd. The same gate voltage (control voltage) VG, specifically a gate-source voltage (VGS), as that of the pMOS transistor MPd, is applied to the pMOS transistor MPsen. As a result, the pMOS transistor MPsen functions as a current sense transistor that makes a flow of a detection current Isen proportional to the output power current IoutL output from the LDO regulator LDOR. On the other hand, the sense resistor element Rsen converts the detection current Isen into a frequency control voltage Vctl. In other words, the sense resistor element Rsen functions as a current-voltage converter IVC.

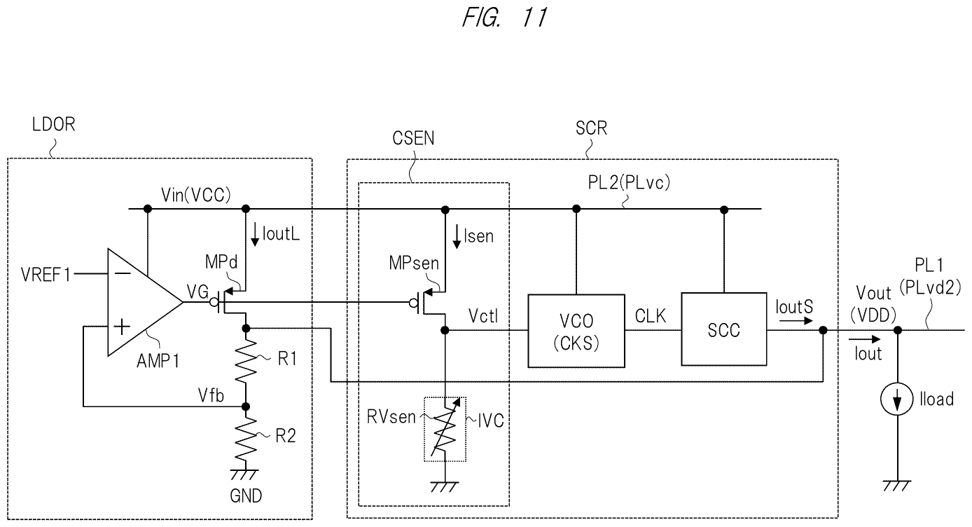

FIG. 10A is a circuit diagram illustrating a configuration example of the voltage controlled oscillator VCO in FIG. 9. FIG. 10B is a circuit diagram illustrating a configuration example of a ring oscillator ROSC in FIG. 10A. The voltage controlled oscillator VCO illustrated in FIG. 10A includes an integration circuit ITC, a high-potential side bias circuit IBS1, a low-potential side bias circuit IBS2, and the ring oscillator ROSC. The ring oscillator ROSC includes a plurality of cascaded inverter circuits IV and an input-output feedback wiring as illustrated in FIG. 10B.

The integration circuit ITC includes an amplifier circuit AMPc and an integration capacitor Cc. The amplifier circuit AMPc integrates an error between a predetermined reference voltage VREFc and the frequency control voltage Vctl by using the integration capacitor Cc. The amplifier circuit AMPc outputs the integration result as a gate voltage (bias control voltage) VGc. The two bias circuits IBS1 and IBS2 generate bias currents Ibs based on the integration result. The ring oscillator ROSC is operated by the bias currents Ibs.

Specifically, the bias circuit IBS1 includes a pMOS transistor MPc2 and a resistor element Rc2. The pMOS transistor MPc2 supplies the bias current Ibs based on the gate voltage VGc to the high-potential side power node of the ring oscillator ROSC. The resistor element Rc2 is connected between the power wiring PL2 and the source of the pMOS transistor MPc2.

The bias circuit IBS2 includes a pMOS transistor MPc1, a resistor element Rc1, and two nMOS transistors MNc1 and MNc2. The pMOS transistor MPc1 makes the flow of the bias current Ibs based on the gate voltage VGc. The resistor element Rc1 is connected between the power wiring PL2 and the source of the pMOS transistor MPc1. The nMOS transistors MNc1 and MNc2 form a current mirror circuit. The nMOS transistor MNc1 transfers the bias current Ibs flowing through the pMOS transistor MPc1, to the nMOS transistor MNc2. The nMOS transistor MNc2 supplies the transferred bias current Ibs to the low-potential side power node of the ring oscillator ROSC.

The inverter circuits IV in the ring oscillator ROSC perform a signal inverting operation at a speed depending on the magnitude of the supplied bias current Ibs. As a result, the ring oscillator ROSC generates the clock signal CLK having a frequency depending on the magnitude of the supplied bias current Ibs.

In this case, for example, in the case of “Vctl<VREFc”, the integration circuit ITC outputs a relatively high voltage as the gate voltage (bias control voltage) VGc. As a result, the two bias circuits IBS1 and IBS2 do not output the desired bias current Ibs, and the ring oscillator ROSC does not generate the clock signal CLK. On the other hand, in the case of “Vctl>VREFc”, the integration circuit ITC outputs a voltage as the gate voltage VGc, the voltage decreasing depending on the error “Vctl−VREFc”. Thus, the two bias circuits IBS1 and IBS2 supply the bias current Ibs proportional to the magnitude of the error to the ring oscillator ROSC. As a result, the ring oscillator ROSC starts an operation of generating the clock signal CLK.

In such a manner, the voltage controlled oscillator VCO starts the operation of generating the clock signal CLK when the frequency control voltage Vctl is larger than the operation lower limit value based on the reference voltage VREFc. The voltage controlled oscillator VCO controls the frequency of the clock signal CLK, based on the magnitude of the error “Vctl−VREFc”. As a result, the switched-capacitor circuit SCC outputs the output power current IoutS based on the magnitude of the error “Vctl−VREFc”.

The output power current IoutL from the LDO regulator LDOR decreases by the output power current IoutS output from the switched-capacitor circuit SCC. As a result, the error “Vctl−VREFc” in the integration circuit ITC becomes zero, and the voltage regulator is operated in a steady state. In such a manner, in the range of operation of the switched-capacitor circuit SCC, the voltage controlled oscillator VCO performs control such that the increase in the load current Iload is compensated by the output power current IoutS output from the switched-capacitor circuit SCC.

### <Details of Voltage Regulator (Modification Example)>

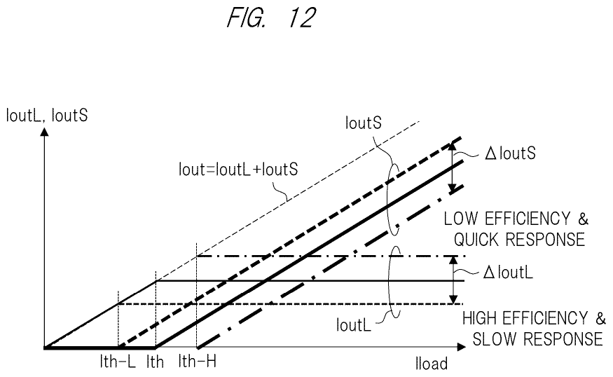

FIG. 11 is a circuit block diagram illustrating a configuration example of a modification of the voltage regulator illustrated in FIG. 9. A voltage regulator illustrated in FIG. 11 differs from the configuration example illustrated in FIG. 9 in the following point. In other words, a sense resistor element RVsen in the current detecting circuit CSEN includes a variable resistor element.

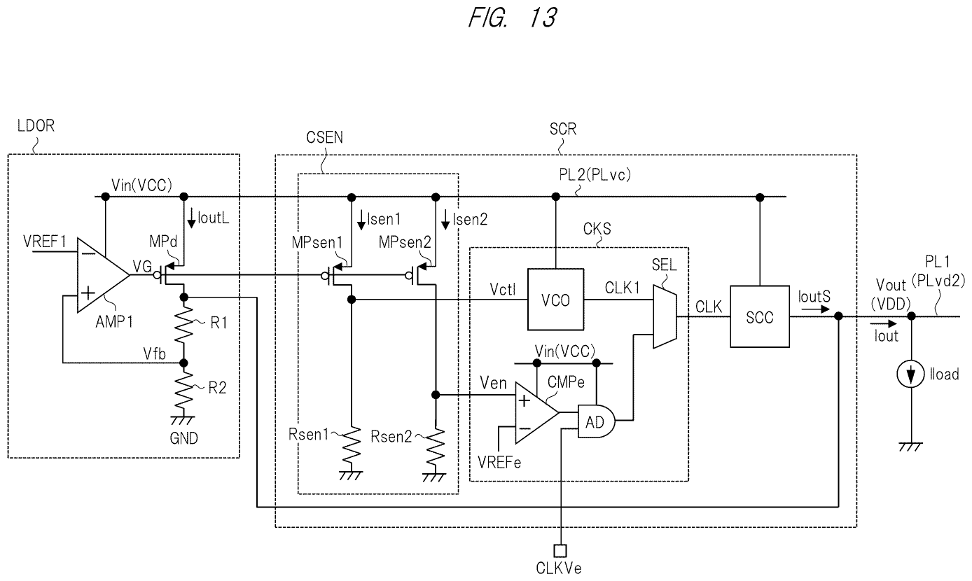

FIG. 12 is a schematic diagram illustrating an operation example of the voltage regulator illustrated in FIG. 11. FIG. 12 illustrates relationships between the load current Iload and two output power currents IoutL and IoutS as similar to the case of FIG. 7. However, since the variable resistor element is arranged in FIG. 12, the threshold value Ith illustrated in FIG. 7 can be variably set. Thus, the magnitude of the output power current IoutS from the switched-capacitor circuit SCC to the certain load current Iload can be adjusted with a predetermined adjustment interval ΔIoutS. Based on the above, the magnitude of the output power current IoutL from the LDO regulator LDOR in the range of operation of the switched-capacitor circuit SCC can also be adjusted with a predetermined adjustment interval ΔIoutL.

For example, in a case of use of a low threshold value Ith-L, the range of the operation of the switched-capacitor circuit SCC is widened. Thus, the output power current IoutL from the LDO regulator LDOR in the range is decreased. In this case, the power efficiency can be further enhanced by widening the range of the operation of the switched-capacitor circuit SCC. On the other hand, the output power current IoutL is decreased, and therefore, the load transient response can become slow.

In a case of use of a high threshold value Ith-H, the range of the operation of the switched-capacitor circuit SCC is narrowed. Thus, the output power current IoutL from the LDO regulator LDOR in the range is increased. In this case, the power efficiency is decreased by narrowing the range of the operation of the switched-capacitor circuit SCC. On the other hand, the output power current IoutL is increased, and therefore, the load transient response can become quick.

As described above, by use of the variable resistor element as the sense resistor element RVsen, the balance between the power efficiency and the load transient response can be flexibly changed depending on demanded requirement specifications. For example, the resistance value of the variable resistor element can be statically set by trimming, or can be dynamically set by an electrical set signal.

### <Principal Effects by First Embodiment>

As described above, in the system according to the first embodiment, the LDO regulator LDOR and the switched-capacitor circuit SCC are connected in parallel. The output power current IoutL from the LDO regulator LDOR is detected, and the clock signal CLK for the switched-capacitor circuit SCC is controlled based on the detection result. As a result, the high power efficiency, the quick load transient response, and the decrease in BoM cost can be achieved in the voltage regulator.

### Second Embodiment

### <Details of Voltage Regulator>

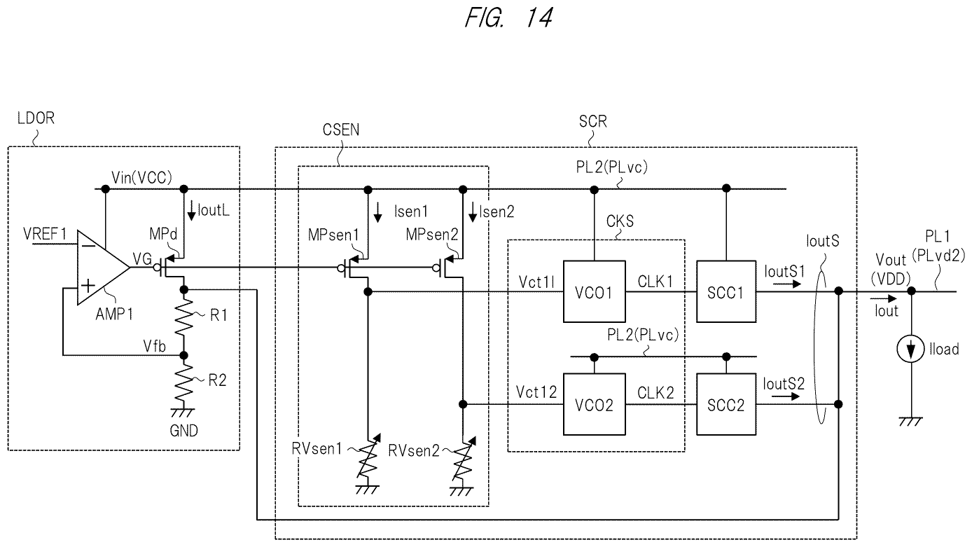

FIG. 13 is a circuit block diagram illustrating a detailed configuration example of the voltage regulator illustrated in FIG. 6, in a semiconductor device according to a second embodiment. A voltage regulator illustrated in FIG. 13 differs from the configuration example illustrated in FIG. 9 in the following two points. The first difference is that the current detecting circuit CSEN includes a pMOS transistor MPsen2 and a sense resistor element Rsen2 in addition to the pMOS transistor MPsen1 and the sense resistor element Rsen1 as similar to those in the case of FIG. 9. The second difference is that the clock supply circuit CKS includes a comparator circuit CMPe, an AND gate AD, and a selector circuit SEL in addition to the voltage controlled oscillator VCO as similar to that in the case of FIG. 9.

The same gate voltage VG as that of the pMOS transistor MPsen1, accordingly a pMOS transistor MPd which is an output transistor, is applied to the pMOS transistor MPsen2. As a result, a detection current Isen2 proportional to the magnitude of the output power current IoutL also flows through the pMOS transistor MPsen2. The sense resistor element Rsen2 converts the detection current Isen2 into an enable voltage Ven. Note that the sense resistor element Rsen1 converts the detection current Isen1 flowing through the pMOS transistor MPsen1 into the frequency control voltage Vctl, and outputs the converted result to the voltage controlled oscillator VCO as similar to that in the case of FIG. 9.

The comparator circuit CMPe compares the enable voltage Ven with a reference voltage VREFe, and outputs a signal of an “H” level in the case of “Ven>VREFe”. The AND gate AD outputs a variable clock signal CLKVe input from the outside when the comparator circuit CMPe outputs the “H” level. The selector circuit SEL selects either one of the variable clock signal CLKVe output from the AND gate AD and the clock signal CLK1 output from the voltage controlled oscillator VCO, as similar to that in the case of FIG. 9. The selector circuit SEL supplies the selected clock signal CLK to the switched-capacitor circuit SCC.

In this case, for example, a clock signal having a frequency depending on a processing load may be supplied to the processor PRC that is illustrated in FIG. 1 and is one of the loads of the voltage regulator. This clock signal is input as the variable clock signal CLKVe to the AND gate AD illustrated in FIG. 13. The comparator circuit CMPe allows the AND gate AD to output the variable clock signal CLKVe when the magnitude of the detection current Isen2, accordingly the output power current IoutL, is larger than a threshold value based on the reference voltage VREFe. On the other hand, the comparator circuit CMPe allows the AND gate AD to mask the output of the variable clock signal CLKVe when the magnitude of the output power current IoutL is not larger than the threshold value.

As a result, an operation similar to that in the case of FIG. 7 is performed by using the variable clock signal CLKVe. In this case, the threshold value Ith illustrated in FIG. 7 is defined based on the reference voltage VREFe applied to the comparator circuit CMPe. The variable clock signal CLKVe is a signal having a frequency that is increased by increase in the output power current IoutL as similar to the clock signal CLK output from the voltage controlled oscillator VCO illustrated in FIG. 9.

Note that the variable clock signal CLKVe does not always need to be arranged. Therefore, in the example illustrated in FIG. 13, the selector circuit SEL is configured to be able to also select the clock signal CLK1 output from the voltage controlled oscillator VCO. On the other hand, a configuration in which only the variable clock signal CLKVe is used is also acceptable when the variable clock signal CLKVe is arranged while the load current is substantially defined by the processor PRC. In this case, the pMOS transistor MPsen1 and the sense resistor element Rsen1 as well as the voltage controlled oscillator VCO and the selector circuit SEL, illustrated in FIG. 13, can be eliminated.

In such an example, the variable clock signal CLKVe is used as the clock signal CLK used for the switched-capacitor circuit SCC as it is. However, the clock signal CLK used for the switched-capacitor circuit SCC may be, for example, a clock signal obtained by, for example, dividing the variable clock signal CLKVe by a fixed division ratio. In other words, the clock signal CLK is sufficient to be a signal based on the variable clock signal CLKVe.

Furthermore, the variable clock signal CLKVe is not always limited to the clock signal used for the processor PRC, but may be an external clock signal input from the outside of the clock supply circuit CKS. In this case, the external clock signal may be a signal having a frequency that changes depending on a processing load in the load.

### <Principal Effects by Second Embodiment>

As described above, effects similar to the various effects described in the first embodiment can be obtained by using the system according to the second embodiment. Furthermore, such effects can be obtained by effectively utilizing an existing variable clock signal CLKVe.

### Third Embodiment

### <Problems to be Premised>

As illustrated in FIG. 5B, the switched-capacitor circuit SCC generates the output power current Iout by, for example, periodically repeating the operations of charging and discharging into and from the flying capacitor Cfly. Therefore, a periodic ripple is generated in principle in the output power voltage Vout. For example, when the output power voltage Vout is made larger than an expected voltage range by a large ripple voltage, the load such as the internal power circuit 17 may malfunction. Thus, use of the following system is beneficial.

### <Details of Voltage Regulator>

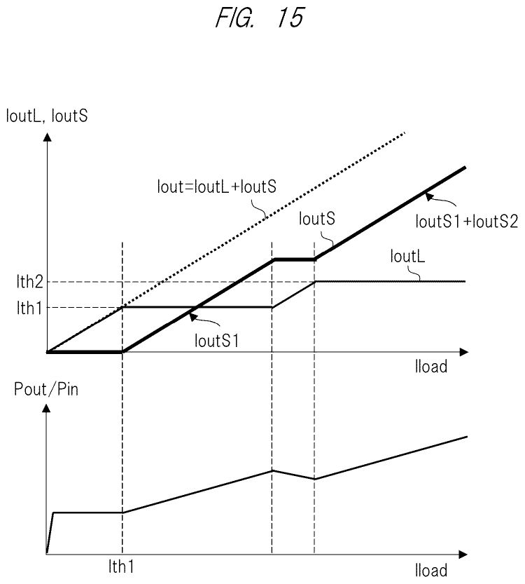

FIG. 14 is a circuit block diagram illustrating a detailed configuration example of the voltage regulator illustrated in FIG. 6, in a semiconductor device according to a third embodiment. The voltage regulator illustrated in FIG. 14 differs from the configuration example illustrated in FIG. 11 in the following point. In other words, the voltage regulator includes a plurality of sets, here, two sets each made of the pMOS transistor MPsen, the sense resistor element RVsen, the voltage controlled oscillator VCO, and the switched-capacitor circuit SCC as illustrated in FIG. 11.

In the first set, a pMOS transistor MPsen1 and a sense resistor element RVsen1 generate a frequency control voltage Vctl1 based on a detection current Isen1. A voltage controlled oscillator VCO1 generates a clock signal CLK1 based on the frequency control voltage Vctl1, and supplies the clock signal CLK1 to a switched-capacitor circuit SCC1. Similarly, in the second set, a pMOS transistor MPsen2 and a sense resistor element RVsen2 generate a frequency control voltage Vctl2 based on a detection current Isen2. A voltage controlled oscillator VCO2 generates a clock signal CLK2 based on the frequency control voltage Vctl2, and supplies the clock signal CLK2 to a switched-capacitor circuit SCC2.

The switched-capacitor circuit SCC1 outputs an output power current IoutS1 to the power wiring PL1. The switched-capacitor circuit SCC2 outputs an output power current IoutS2 to the same power wiring PL1. As similar to the case of FIG. 11, here, the two sense resistor elements RVsen1 and RVsen2 are variable resistor elements. It is assumed here that the values of the two detection currents Isen1 and Isen2 are equal to each other, that is, the sizes of two pMOS transistors MPsen1 and MPsen2 are equal to each other. In this case, the two sense resistor elements RVsen1 and RVsen2 are set to have resistance values different from each other.

As described above, in FIG. 14, one switched-capacitor circuit SCC illustrated in FIG. 11 is divided into the plurality of switched-capacitor circuits SCC1 and SCC2. Thus, the capacitance value of the flying capacitor Cfly per the divided switched-capacitor circuit can be decreased, and therefore, the ripple voltage can be decreased. Furthermore, the amount of output current per the divided switched-capacitor circuit can be decreased, and therefore, a control gain of a control loop can be decreased.

The control loop is a loop in which the output power current IoutS of each switched-capacitor circuit SCC changes depending on the output power current IoutL of the LDO regulator LDOR, accordingly, the output power current IoutL changes again. In such a control loop, for example, as illustrated in FIG. 10A, phase compensation can be facilitated by applying an integration capacitor Cc to an amplifier circuit AMPc or decreasing the gain of the amplifier circuit AMPc. As a result, the stability of the control loop is easily ensured.

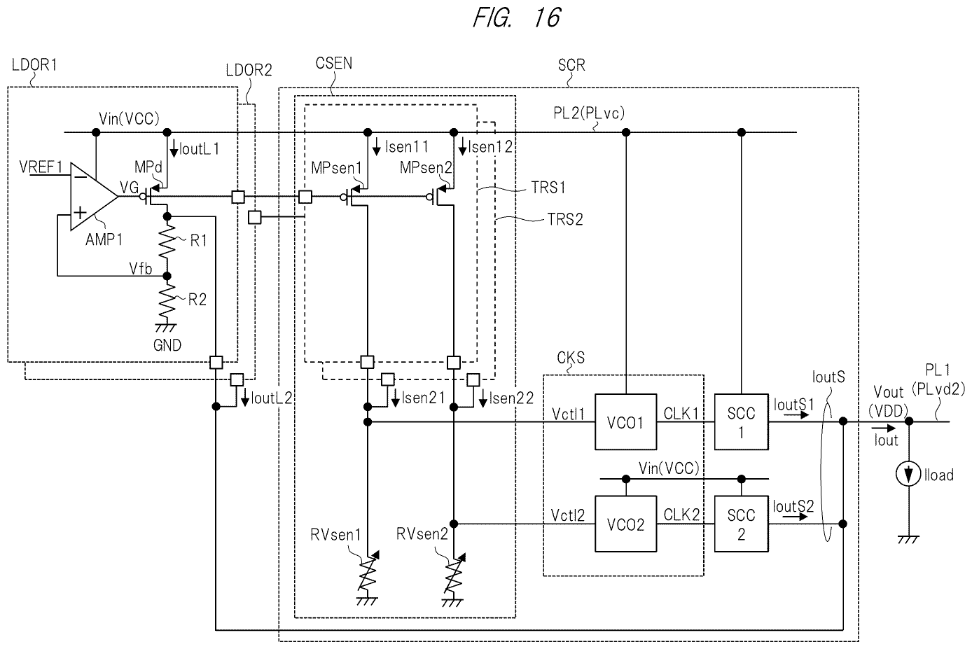

FIG. 15 is a schematic diagram illustrating an operation example of the voltage regulator illustrated in FIG. 14. As similar to the case of FIG. 7, FIG. 15 illustrates relationships between the load current Iload, the two output power currents IoutL and IoutS, and the power efficiency “Pout/Pin”. The value of the output power current IoutS is a sum of the two output power currents IoutS1 and IoutS2 output from the two switched-capacitor circuits SCC1 and SCC2.

In FIG. 15, the voltage controlled oscillator VCO1 starts the operation of generating the clock signal CLK1 when the output power current IoutL from the LDO regulator LDOR is larger than a threshold value (first threshold value) Ith1. As similar to the case of FIG. 7, the voltage controlled oscillator VCO1 performs control such that the increase in the load current Iload is compensated by the output power current IoutS1 of the switched-capacitor circuit SCC1. As a result, the power efficiency “Pout/Pin” can be enhanced. Note that the threshold value Ith1 is defined by the resistance value of the sense resistor element RVsen1.

The divided switched-capacitor circuit SCC1 has a smaller ability to supply the current due to the decreased capacity of the flying capacitor Cfly than that in the case of FIG. 9. Therefore, when the increase in the load current Iload is larger than the ability of the switched-capacitor circuit SCC1 to supply the current, the increase is compensated by the LDO regulator LDOR. As described above, the power efficiency “Pout/Pin” decreases by such an increase in the output power current IoutL of the LDO regulator LDOR.

However, the further increase in the load current Iload, accordingly the further increase in the output power current IoutL output from the LDO regulator LDOR activates the switched-capacitor circuit SCC2. In other words, the voltage controlled oscillator VCO2 starts the operation of generating the clock signal CLK2 when the output power current IoutL is larger than a threshold value (second threshold value) Ith2. Note that the voltage controlled oscillator VCO2 performs control such that the further increase in the load current Iload is compensated by the output power current IoutS2 of the switched-capacitor circuit SCC2. Note that the threshold value Ith2 is defined by the resistance value of the sense resistor element RVsen2, and is different from the threshold value Ith1.

### <Principal Effects by Third Embodiment>

As described above, effects similar to the various effects described in the first embodiment can be obtained by using the system according to the third embodiment. Furthermore, the ripple voltage generated in the output power voltage Vout can be decreased by dividing the switched-capacitor circuit SCC.

### Fourth Embodiment

### <Details of Voltage Regulator>

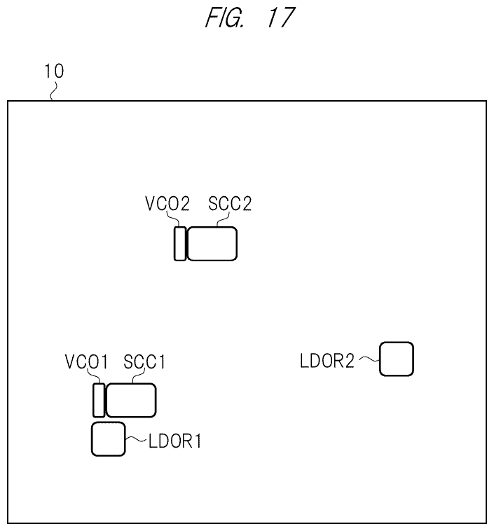

FIG. 16 is a circuit block diagram illustrating a detailed configuration example of the voltage regulator illustrated in FIG. 6, in a semiconductor device according to a fourth embodiment. A voltage regulator illustrated in FIG. 16 differs from the configuration example illustrated in FIG. 14 in the following two points. The first difference is that a plurality of, in this example, two LDO regulators LDOR1 and LDOR2 are arranged. The second difference is that the current detecting circuit CSEN includes two current sense transistor groups TRS1 and TRS2 depending on the two LDO regulators LDOR1 and LDOR2.

The two LDO regulators LDOR1 and LDOR2 output two output power currents IoutL1 and IoutL2 to the common power wiring PL1, respectively. Meanwhile, as similar to the case of FIG. 14, the current sense transistor group TRS1 includes two pMOS transistors MPsen1 and MPsen2. The two pMOS transistors MPsen1 and MPsen2 make flows of two detection currents Isen11 and Isen12 proportional to the magnitude of the output power current IoutL1 of the LDO regulator LDOR1. As similar to the case of FIG. 14, the two detection currents Isen11 and Isen12 may have the same value as each other.

Similarly, although not illustrated, the current sense transistor group TRS2 includes two pMOS transistors MPsen1 and MPsen2. The two pMOS transistors MPsen1 and MPsen2 make flows of two detection currents Isen21 and Isen22 proportional to the magnitude of the output power current IoutL2 of the LDO regulator LDOR2. The two detection currents Isen21 and Isen22 may also have the same value as each other.

A sense resistor element RVsen1 sums the currents output from the two pMOS transistors MPsen1 included in the two current sense transistor groups TRS1 and TRS2, and converts the summed current into a frequency control voltage Vctl1. In other words, the sense resistor element RVsen1 converts the summed current of the two detection currents Isen11 and Isen21 into the frequency control voltage Vctl1. Similarly, a sense resistor element RVsen2 sums the currents output from the two pMOS transistors MPsen2 included in the two current sense transistor groups TRS1 and TRS2, and converts the summed current into a frequency control voltage Vctl2. In other words, the sense resistor element RVsen2 converts the summed current of the two detection currents Isen12 and Isen22 into the frequency control voltage Vctl2.

In such a manner, the current detecting circuit CSEN detects the magnitude of the summed current of the two output power currents IoutL1 and IoutL2 output from the plurality of, in this example, two LDO regulators LDOR1 and LDOR2. The clock supply circuit CKS supplies the clock signals CLK to the switched-capacitor circuits SCC, based on the magnitude of the summed current. In this example, a voltage controlled oscillator VCO1 supplies the clock signal CLK1 to the switched-capacitor circuit SCC1, based on the frequency control voltage Vctl1 representing the magnitude of the summed current. A voltage controlled oscillator VCO2 also supplies the clock signal CLK2 to the switched-capacitor circuit SCC2, based on the frequency control voltage Vctl2 representing the magnitude of the summed current.

In this case, note that the case of arranging the two switched-capacitor circuits SCC1 and SCC2 is exemplified. However, the same also applies to the case of arranging one switched-capacitor circuit SCC. In this case, the pMOS transistor MPsen2 and the sense resistor element RVsen2, the voltage controlled oscillator VCO2, and the switched-capacitor circuit SCC2 are eliminated from the configuration of FIG. 16.

In other words, in a basic configuration, one switched-capacitor circuit SCC is assigned to “N” LDO regulators LDOR. The one switched-capacitor circuit SCC is controlled based on a summed current output from the N LDO regulators LDOR. In this basic configuration, the switched-capacitor circuit SCC may be divided as described in FIG. 14.

For example, a configuration is conceivable, in which a plurality of sets each made of the LDO regulator LDOR and the switched capacitor regulator SCR illustrated in FIG. 11 are commonly connected to the power wiring PL1. However, in this case, the operations of the switched capacitor regulators SCR may lean to any set of the plurality of sets. On the other hand, as illustrated in FIG. 16, such leaning can be prevented by using the summed current output from the N LDO regulators LDOR.

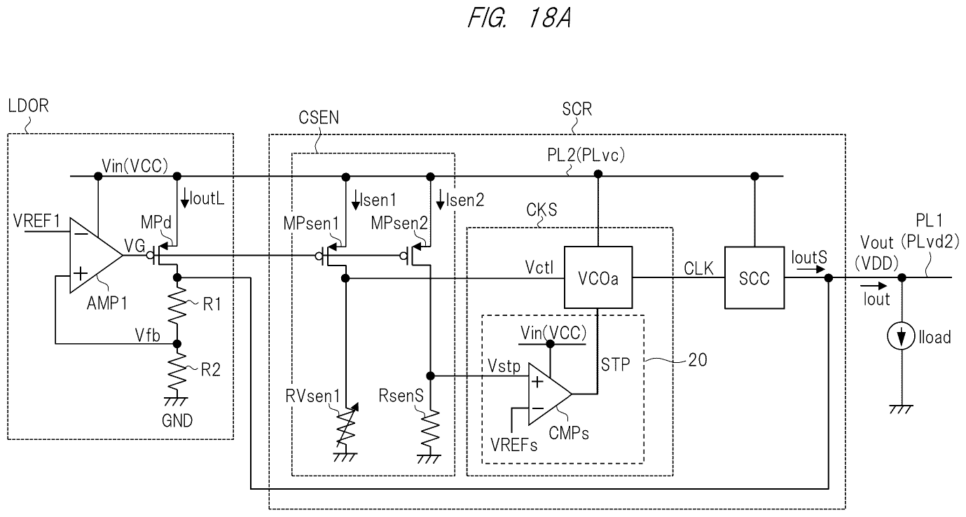

FIG. 17 is a schematic diagram illustrating an arrangement example of the voltage regulator illustrated in FIG. 16 in the semiconductor device. In the example illustrated in FIG. 17, the two LDO regulators LDOR1 and LDOR2 are dispersedly arranged in the semiconductor device 10. The voltage controlled oscillator VCO1 and the switched-capacitor circuit SCC1 are arranged near the LDO regulator LDOR1. On the other hand, the voltage controlled oscillator VCO2 and the switched-capacitor circuit SCC2 are arranged to be far from the LDO regulator LDOR2.

As described above, the plurality of LDO regulators LDOR and the plurality of switched-capacitor circuits SCC may be appropriately dispersedly arranged in the semiconductor device 10. In a specific example, these components may be arranged near positions of loads consuming the large current. As a result, an IR drop in the whole semiconductor device 10 can be suppressed. The number of arranged LDO regulators LDOR and the number of arranged switched-capacitor circuits SCC can be appropriately adjusted in accordance with the amount of current required in the load.

### <Principal Effects by Fourth Embodiment>

As described above, effects similar to the various effects described in the first embodiment can be obtained by using the system according to the fourth embodiment. Furthermore, the switched-capacitor circuits SCC can be appropriately operated even when the plurality of LDO regulators LDOR are connected to the common power wiring.

### Fifth Embodiment

### <Problems to Be Premised>

For example, it is assumed that the load current Iload is rapidly decreased by an external reset instruction. In this case, in the LDO regulator LDOR, the output power current IoutL can be rapidly decreased in response to the rapid decrease in the load current Iload by the quick load transient response. On the other hand, the load transient response of the switched-capacitor circuit SCC is slower than that of the LDO regulator LDOR because of the circuit configuration.

Furthermore, in the system according to the embodiment, the control loop is formed as described above. Even by the control loop, the load transient response of the switched-capacitor circuit SCC may be made slow. Therefore, the switched-capacitor circuit SCC continues to output the output power current IoutS for a while even when the load current Iload is rapidly decreased. As a result, there is a risk of the increase in the output power voltage Vout to be larger than a breakdown voltage of the load. Thus, use of the following system is beneficial.

### <Details of Voltage Regulator>

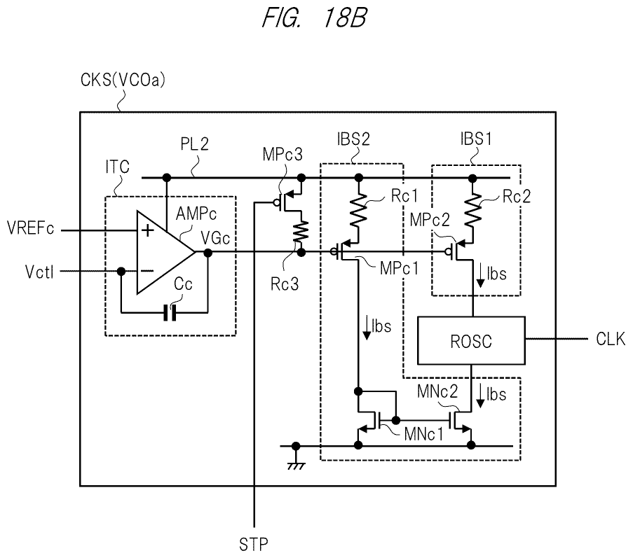

FIG. 18A is a circuit block diagram illustrating a detailed configuration example of the voltage regulator illustrated in FIG. 6, in a semiconductor device according to a fifth embodiment. FIG. 18B is a circuit diagram illustrating a configuration example of a voltage controlled oscillator VCOa in FIG. 18A. A voltage regulator illustrated in FIG. 18A differs from the configuration example illustrated in FIG. 11 in the following three points.

The first difference is that the current detecting circuit CSEN includes the pMOS transistor MPsen2 and the sense resistor element RsenS in addition to the pMOS transistor MPsen1 and the sense resistor element RVsen1 as similar to those in the case of FIG. 11. The second difference is that the clock supply circuit CKS includes the voltage controlled oscillator VCOa slightly different from that in the case of FIG. 11. The third difference is that the clock supply circuit CKS includes a disconnection circuit 20.

The same gate voltage VG as that of the pMOS transistor MPsen1, accordingly a pMOS transistor MPd which is an output transistor, is applied to the pMOS transistor MPsen2. As a result, the detection current Isen2 proportional to the magnitude of the output power current IoutL also flows through the pMOS transistor MPsen2. The sense resistor element RsenS converts the detection current Isen2 into a stop voltage Vstp. As similar to the case of FIG. 11, note that the sense resistor element RVsen1 converts the detection current Isen1 flowing through the pMOS transistor MPsen1 into the frequency control voltage Vctl, and outputs the frequency control voltage Vctl to the voltage controlled oscillator VCOa.

As illustrated in FIG. 18B, the voltage controlled oscillator VCOa includes a pMOS transistor MPc3 and a resistor element Rc3 in addition to each circuit illustrated in FIG. 10A. When a stop signal STP is asserted to be at an “L” level, the pMOS transistor MPc3 make the short circuit of the output node of the integration circuit ITC to the power wiring PL2 through the resistor element Rc3. On the other hand, the disconnection circuit 20 illustrated in FIG. 18A includes a comparator circuit CMPs. The comparator circuit CMPs compares a reference voltage VREFs and the stop voltage Vstp, and asserts the stop signal STP to be at the “L” level in the case of “Vstp<VREFs”.

When the stop signal STP is asserted, two bias circuits IBS1 and IBS2 stop supply of the bias current Ibs at a predetermined time constant based on a resistor element Rc3 and an integration capacitor Cc. As a result, the voltage controlled oscillator VCOa stops supply of the clock signal CLK to the switched-capacitor circuit SCC. The reference voltage VREFs is set to have a value that is, for example, lower than the threshold value Ith illustrated in FIG. 7. The predetermined time constant is set to a certain short time.

As described above, the clock supply circuit CKS includes the disconnection circuit 20 that urgently stops the supply of the clock signal CLK to the switched-capacitor circuit SCC when the output power current IoutL is smaller than a predetermined value. For example, the voltage controlled oscillator VCO illustrated in FIG. 10A may require a certain time for stopping the supply of the clock signal CLK in accordance with the rapid decrease of the load current Iload. In this case, the clock signal CLK can be rapidly stopped by using the voltage controlled oscillator VCOa illustrated in FIG. 10B.

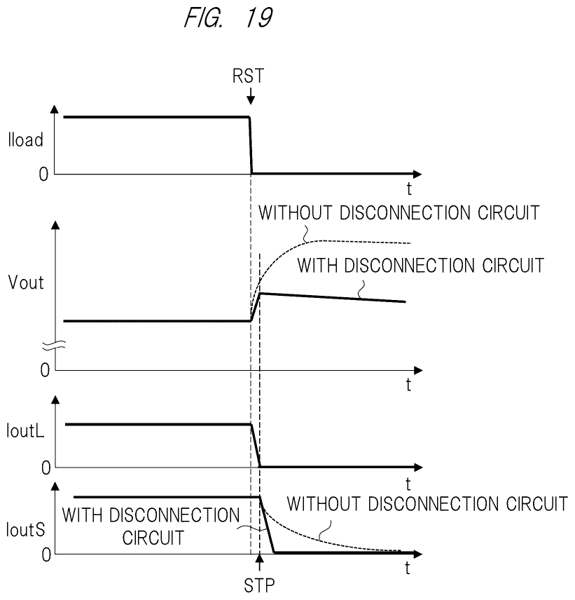

FIG. 19 is a timing chart illustrating an operation example of the voltage regulator illustrated in FIG. 18A. In FIG. 19, for example, at a certain moment, the external reset instruction RST is input, and the load current Iload is rapidly decreased. Accordingly, the output power current IoutL output from the LDO regulator LDOR is also rapidly decreased. However, in a case without the disconnection circuit 20, the output power current IoutS output from the switched-capacitor circuit SCC is gradually decreased. In this case, the output power voltage Vout may be larger than the breakdown voltage of the load.

On the other hand, in the case with the disconnection circuit 20 as illustrated in FIG. 18A, the output power current IoutS output from the switched-capacitor circuit SCC is rapidly decreased by the stop signal STP. As a result, the increase in the output power voltage Vout due to the rapid decrease in the load current Iload can be suppressed. In other words, the output power voltage Vout can be suppressed not to be larger than the breakdown voltage of the load.

### <Principal Effects by Fifth Embodiment>

As described above, effects similar to the various effects described in the first embodiment can be obtained by using the system according to the fifth embodiment. Furthermore, the increase in the output power voltage Vout due to the rapid decrease in the load current Iload can be suppressed.

In the foregoing, the invention made by the inventors of the present application has been concretely described based on the embodiments. However, the present invention is not limited to the foregoing embodiments, and various modifications can be made within the scope of the present invention. For example, the above-described embodiments have been explained in detail for making the present invention understandable, and are not always limited to the one including all structures explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

What is claimed is:

1. A semiconductor device comprising:
a first power wiring through which power is supplied to a predetermined load;
a low drop out (LDO) regulator to which an input power voltage is input, and which outputs a first output power current and a first output power voltage lower than the input power voltage to the first power wiring;
a switched-capacitor circuit to which the input power voltage is input, and which outputs a second output power current to the first power wiring by performing switching in accordance with a clock signal to alternately perform switching between a charge operation and a discharge operation for a flying capacitor;
a current detecting circuit which detects a magnitude of the first output power current; and
a clock supply circuit which supplies the clock signal to the switched-capacitor circuit, based on a detection result of the current detecting circuit.

2. The semiconductor device according to claim 1,
wherein the clock supply circuit starts supply of the clock signal to the switched-capacitor circuit when the magnitude of the first output power current is larger than a predetermined threshold value.

3. The semiconductor device according to claim 2,
wherein the clock supply circuit is further configured to increase a frequency of the clock signal in accordance with an increase in the first output power current.

4. The semiconductor device according to claim 3,
wherein the LDO regulator includes:
an output transistor connected between the first power wiring and a second power wiring to which the input power voltage is applied; and
an amplifier circuit which applies a control voltage to the output transistor such that an error between a value of the first output power voltage and a target value approaches zero,
wherein the current detecting circuit includes:
a current sense transistor which is made of a transistor set to have a predetermined size ratio to the output transistor, and which makes a flow of a detection current proportional to the first output power current when the same control voltage as the control voltage applied to the output transistor is applied to the current sense transistor; and
a sense resistor element which converts the detection current into a frequency control voltage,
wherein the clock supply circuit is made of a voltage controlled oscillator, and
wherein the voltage controlled oscillator starts an operation of generating the clock signal when the frequency control voltage is larger than an operation lower limit value, and determines the frequency of the clock signal, based on the frequency control voltage.

5. The semiconductor device according to claim 4,
wherein the sense resistor element is a variable resistor element.

6. The semiconductor device according to claim 4,
wherein the voltage controlled oscillator includes:
an integration circuit which integrates an error between the frequency control voltage and a predetermined reference voltage;
a bias circuit which generates a bias current based on an integration result of the integration circuit; and
a ring oscillator which is operated by the bias current.

7. The semiconductor device according to claim 2,
wherein an external clock signal is input from outside to the clock supply circuit, and the clock supply circuit is configured to supply the clock signal based on the external clock signal to the switched-capacitor circuit when the magnitude of the first output power current is larger than the threshold value.

8. The semiconductor device according to claim 7,
wherein the load includes a processor,
wherein a variable clock signal having a frequency changing depending on a processing load is supplied to the processor, and
wherein the external clock signal is the variable clock signal.

9. The semiconductor device according to claim 2, further comprising
a plurality of sets including a first set and a second set each made of the switched-capacitor circuit and the clock supply circuit,
wherein a clock supply circuit included in the first set starts supply of the clock signal to a switched-capacitor circuit included in the first set when the magnitude of the first output power current is larger than a predetermined first threshold value,
wherein a clock supply circuit included in the second set starts supply of the clock signal to a switched-capacitor circuit included in the second set when the magnitude of the first output power current is larger than a predetermined second threshold value, and
wherein the first threshold value and the second threshold value are different from each other.

10. The semiconductor device according to claim 2, further comprising
a plurality of the LDO regulators,
wherein each of the plurality of LDO regulators outputs the first output power current to the common first power wiring, and
wherein the current detecting circuit detects a magnitude of a summed current of the first output power currents output from the plurality of LDO regulators.

11. The semiconductor device according to claim 2,
wherein the clock supply circuit includes a disconnection circuit which urgently stops supply of the clock signal to the switched-capacitor circuit when the magnitude of the first output power current is smaller than a predetermined value.
